(19) United States
(12) Patent Application Publication
(10) Pub. No.: US 2022/0325182 A1
(43) Pub. Date: Oct. 13, 2022

(54) LIQUID COMPOSITION, FIREPROOF LAYER, LAMINATED STRUCTURE INCLUDING FIREPROOF LAYER, AND FIREPROOFING METHOD

(71) Applicant: 3M INNOVATIVE PROPERTIES COMPANY, St. Paul, MN (US)

(72) Inventors: Hiroki Arazoe, Tokyo (JP); Shinsuke Kondo, Yamagata (JP); Naota Sugiyama, Kanagawa (JP); Kenji Koizumi, Kokubunji (JP); Yuki Kubota, Kanagawa (JP)

(21) Appl. No.: 17/628,613

(22) PCT Filed: Jul. 21, 2020
(86) PCT No.: PCT/IB2020/056859

§ 371 Date: Jan. 20, 2022

(30) Foreign Application Priority Data
Jul. 22, 2019 (JP) 2019-134603

(51) Int. Cl. C09K 21/04; C09K 21/02; C09K 21/14; C09D 5/18; C09D 1/02

(52) U.S. Cl. CPC C09K 21/04; C09K 21/02; C09K 21/14; C09D 5/18; C09D 1/02

(57) ABSTRACT

A liquid composition including clay containing at least one selected from the group consisting of a montmorillonite, mica, hectorite, and fluorosilicate; and a dimer or higher phosphate is described. Such liquid compositions are capable of forming a fireproof layer having high fireproof performance on a surface of a base material to which a film for wallpaper or the like is applied. A fireproof layer which can be formed using the liquid composition, a laminated structure including the fireproof layer, and a fireproofing method using the liquid composition are also described.

### TECHNICAL FIELD

The present disclosure relates to a liquid composition, a fireproof layer, a laminated structure including the fireproof layer, and a fireproofing method.

### BACKGROUND ART

In a building, a vehicle, a traffic sign, a signboard, a packaging material and the like, a decorative film or a sheet provided with a pressure sensitive adhesive layer on a film base material is used. For example, films for wallpaper used for an interior of a building are required to be certified as nonflammable materials based on building standards laws and the like of each country.

As a method of enhancing nonflammablity of a decorative film for an interior, a method of adding a flame retardant to a pressure sensitive adhesive on a back side of the decorative film or a method of sticking a highly nonflammable material to the decorative film has been known.

For example, Patent Document 1 (JP H10-501009 A) discloses “a pressure sensitive adhesive composition containing from about 10 to about 60% by weight of a non-halogen foamable flame retardant based on the adhesive and containing an adhesive selected from the group consisting of a rubber resin adhesive and an acrylic adhesive”.

Patent Document 2 (JP 2013-44983 A) discloses “a decorative sheet including a film layer and an adhesive layer stacked thereon, a decorative film layer having minute holes having a diameter from 20 to 500 μm and a number density from 2 to 700 pieces/cm², and a glass cloth layer”.

### SUMMARY OF INVENTION

### Technical Problem

However, for example, in a method of testing nonflammable material qualification in Japan, a part of a heat quantity measured by a cone calorimeter comes from the burning or the like of a base material (wall material) to which the film for wallpaper is applied, such as paper covering plasterboard, regardless of the burning of the film for wallpaper. Therefore, even if the nonflammablity of the decorative film for wallpaper alone is improved, the nonflammable material qualification may not be obtained only by the decorative film. Therefore, it is preferable to improve not only the film for wallpaper but also the nonflammablity of the base material to which the film for wallpaper is applied. In addition, by forming a fireproof layer on the surface of the base material such as the plasterboard, it is preferable to further reduce the heat quantity derived from the base material, and enhance a design freedom of the material applied to the surface of the base material, such as the material and thickness of the film for wallpaper.

The present disclosure provides a liquid composition capable of forming a fireproof layer having high fireproof performance on a surface of a base material to which a film for wallpaper or the like is applied, a fireproof layer which can be formed using the liquid composition, a laminated structure including the fireproof layer, and a fireproofing method using the liquid composition.

### Solution to Problem

According to one embodiment, there is provided a liquid composition including: clay containing at least one selected from the group consisting of a montmorillonite, mica, hectorite, and fluorosilicate; and a dimer or higher phosphate.

According to another embodiment, there is provided a fireproof layer including: clay containing at least one selected from the group consisting of a montmorillonite, mica, hectorite, and fluorosilicate; and a dimer or higher phosphate.

According to still another embodiment, there is provided a laminated structure including: a fireproof layer including clay containing at least one selected from the group consisting of a montmorillonite, mica, hectorite, and fluorosilicate, and a dimer or higher phosphate; and a film disposed on the fireproof layer.

According to yet still another embodiment, there is provided a fireproofing method including: preparing a base material; and applying a liquid composition on the base material to form a fireproof layer on the base material, in which the liquid composition contains: clay containing at least one selected from the group consisting of a montmorillonite, mica, hectorite, and fluorosilicate; and a dimer or higher phosphate.

### Advantageous Effects of Invention

According to the present disclosure, it is possible to provide a liquid composition capable of forming a fireproof layer having high fireproof performance on a surface of a base material to which a film for wallpaper or the like is applied, a fireproof layer which can be formed using the liquid composition, a laminated structure including the fireproof layer, and a fireproofing method using the liquid composition.

Note that the above descriptions should not be construed to be a disclosure of all of the embodiments and benefits of the present disclosure.

### BRIEF DESCRIPTION OF DRAWINGS

FIG. 1 is a schematic cross-sectional view of a laminated structure according to one embodiment.

### DESCRIPTION OF EMBODIMENTS

Hereinafter, it will be described in more detail with reference to the drawings for the purpose of illustrating representative embodiments of the present invention, but the present invention is not limited to these embodiments.

In the present disclosure, the term “film” encompasses articles referred to as “sheets”.

In the present disclosure, “pressure sensitive adhering” refers to properties of a material or a composition which has initial tackiness (tack) in an operation temperature range, for example, in the range of 0° C. or higher and 50° C. or lower, adheres to various surfaces with light pressure, and does not exhibit a phase change (from liquid to solid).

A liquid composition according to one embodiment includes: clay containing at least one selected from the group consisting of a montmorillonite, mica, hectorite, and fluorosilicate; and a dimer or higher phosphate. By coating the liquid composition on a surface of a base material (wall material) to which a film for wallpaper or the like is applied in advance, a fireproof layer having fireproof performance can be formed on the surface of the base material.

Clay is a mineral mainly containing layered silicate. The clay containing at least one selected from the group consisting of the montmorillonite, mica, hectorite, and fluorosilicate has a layered structure dispersed in a fireproof layer and arranged in a planar manner, thereby making it possible to impart oxygen barrier property to the fireproof layer. As a result, burning of a base material and the like protected by the fireproof layer and heat generation by the burning can be suppressed. The clays can be used alone or can be used in combination of two or more.

The montmorillonite is a kind of di-octahedral smectite, and is classified into an Na type mainly containing sodium ion as interlayer cation and a Ca type mainly containing calcium ion. The Na type montmorillonite has high swelling property, thickening property, and suspension stability as compared with the Ca type montmorillonite. The use of the Na type montmorillonite is advantageous in that it can impart the oxygen barrier property to the fireproof layer in a small amount. It is advantageous to use the Ca type montmorillonite in that a viscosity of the liquid composition is easily controlled and storage stability is high. When the liquid composition contains the water glass, the Ca type montmorillonite is used to generate a high molecular weight silicic acid compound by a reaction of calcium ions released from the Ca type montmorillonite with the water glass, so the viscosity of the liquid composition can be increased to a desired degree. Examples of the montmorillonite include KUNIPIA-G (Kunimine Industries Co., Ltd., Chiyoda-ku, Tokyo, Japan).

The mica is classified into tri-octahedral mica and di-octahedral mica, any of which can be used. Examples of the tri-octahedral mica include phlogopite, biotite and the like, and examples of the di-octahedral mica include muscovite and the like. It is preferable that the mica has the swelling property. It is preferable that the mica is hydrophilic because it can be highly dispersed in aqueous compositions and has film forming property. Examples of the mica include SOMASIF ME-100 (Katakura & Co-op Agri Corporation, Chiyoda-ku, Tokyo, Japan).

The hectorite is a type of tri-octahedral smectite. It is advantageous that the hectorite is a synthetic hectorite because an average diameter of the layered structure is small and dispersibility is excellent. Examples of the hectorite include LAPONITE-SL 25, LAPONITE-S 482 (all are available from BYK Japan KK., Shinjuku-ku, Tokyo, Japan), and SUMECTON-SWN (available from Kunimine Industries Co., Ltd., Chiyoda-ku, Tokyo, Japan).

The fluorosilicate is a mineral having a layered structure in which a part of clay containing silicate is substituted with fluorine. It is advantageous that the fluorosilicate is a synthetic layered fluorosilicate because the average diameter of the layered structure is small and the dispersibility is excellent. Examples of the fluorosilicate include LAPONITE-JS (BYK Japan KK., Shinjuku-ku, Tokyo, Japan).

It is advantageous for the clay to contain the montmorillonite in terms of the nonflammablity. Although not bound by any theory, the montmorillonite accelerates carbonization of an organic material contacting the montmorillonite in the high temperature environment, such as an organic material contained in an adhesive layer of a decorative film attached on a fireproof layer, in addition to enhancing the oxygen barrier property and as a result, it is considered that the montmorillonite can suppress heat from being generated due to the burning.

In one embodiment, the clay contains a combination of the montmorillonite and at least one selected from the group consisting of mica, hectorite, and fluorosilicate. In this embodiment, the montmorillonite, which has a relatively small surface size of the layered structure, can fill voids of the layered structure of other clays to enhance fireproof performance of the fireproof layer or adhesion to the surface of the base material.

In one embodiment, an average diameter of the layered structure of the clay is about 5 nm or greater, about 10 nm or greater, or about 15 nm or greater, and about 100 μm or less, about 90 μm or less, or about 80 μm or less. In the present disclosure, the average diameter of the layered structure is an average diameter measured by a dynamic light scattering method.

In one embodiment, the clay has water dispersibility. Specifically, it is preferable that the clay has fluidity when 2 g of clay is mixed with 98 g of ion exchanged water. The clay can accelerate the dispersion of the layered structure in the aqueous liquid composition to more efficiently enhance the oxygen barrier property of the fireproof layer.

The clay may be modified with a dispersant, a surface modifier and the like.

In one embodiment, the clay is contained in the liquid composition in amounts of about 30% by mass or greater, about 35% by mass or greater, or about 40% by mass or greater, and about 85% by mass or less, about 80% by mass or less, or about 75% by mass or less based on the solid content of the liquid composition. It is possible to improve flame retardancy by setting the content of the clay to be about 30% by mass or more. It is possible to enhance coating suitability by setting the content of the clay to be about 85% by mass or less.

The dimer or higher phosphate can accelerate the dispersion of the clay in the liquid composition to reduce the viscosity of the liquid composition and enhance the coating suitability thereof. When the layered structure of the clay is dispersed in the liquid composition, a card-house structure (three-dimensional structure in which an end of one layered structure is coordinated to a plane of another layered structure) is formed, and as a result, the liquid composition is excessively thickened. The dimer or higher phosphate can inhibit the formation of the card-house structure by being bonded or coordinated to the end of the layered structure of the clay, and can enhance the dispersibility of the layered structure. The dimer or higher phosphate itself can serve as a nonflammable agent or a flame retardant, for example, as a flame retardant for cellulose.

The dimer or higher phosphate can be represented by Expression: Mₙ₊₂PₙO₃ₙ₊₁. M is a monovalent cation, and is selected from the group consisting of H⁺, Li⁺, Na⁺, and K⁺, and n is an integer from 2 to 30. It is advantageous that M is sodium in terms of price. It is advantageous that n is preferably from 2 to 21 in terms of the dispersibility of the clay. Examples of the dimer or higher phosphate include sodium pyrophosphate and sodium hexametaphosphate. In the preparation of the liquid composition, the phosphate may be in the form of a hydrate, and in this case, hydrated water is contained as a part of a solvent of the liquid composition.

In one embodiment, the dimer or higher phosphate is contained in the liquid composition in amounts of about 0.1% by mass or greater, about 0.5% by mass or greater, or about 1% by mass or greater, and about 10% by mass or less, about 7% by mass or less, or about 5% by mass or less based on the solid content of the liquid composition. The dispersibility of the clay can be improved by setting the content of the dimer or higher phosphate to about 0.1% by mass or greater. By setting the content of the dimer or higher phosphate to be about 10% by mass or less, shrinkage, denaturation and the like of paper covering the base material, particularly the plasterboard, can be suppressed. Shrinkage of the base material during burning can be suppressed, In addition, the hydrated water is not contained in the content of the dimer or higher phosphate.

The liquid composition may further contain a film forming binder containing at least one selected from the group consisting of a water glass and an organic resin. The liquid composition containing the film forming binder can form the fireproof layer excellent in strength, heat resistance or cold resistance, adhesion to a base material, adhesion to a material disposed on the fireproof layer, and the like.

The water glass is condensed during the formation of the fireproof layer to form a silicate coating film, and serves as a clay binder, in particular, as a heat resistant binder. Since the silicate coating film itself also has the oxygen barrier property, the nonflammable performance of the fireproof layer can be further enhanced. The water glass may react with the clay to form a geopolymer, which can effectively suppress the falling of the clay from the fireproof layer.

Examples of the water glass include lithium silicate, sodium silicate, and potassium silicate. Among them, the lithium silicate can be advantageously used in terms of water resistance.

In one embodiment, the water glass is contained in the liquid composition in amounts of about 0.1% by mass or greater, about 0.5% by mass or greater, or about 1% by mass or greater, and about 70% by mass or less, about 65% by mass or less, or about 60% by mass or less based on the solid content of the liquid composition. It is possible to improve fire resistance by setting the content of the water glass to be about 0.1% by mass or greater. By setting the content of the water glass to be about 70% by mass or less, it is possible to suppress the viscosity of the liquid composition from excessively increasing over time and enhance the storage stability of the liquid composition.

Since the organic resin has an affinity to the organic material disposed on the fireproof layer, for example, when the decorative film having an adhesive layer is attached on the fireproof layer, the adhesion of the adhesive layer of the decorative film and the fireproof layer can be enhanced. The organic resin may be a water soluble polymer, and can also be used in the form of an aqueous emulsion.

Examples of the organic resin include polyvinyl chloride, polyvinyl pyrrolidone, an oxazoline group-containing polymer and the like.

In one embodiment, the organic resin is contained in the liquid composition in amounts of about 2% by mass or greater, about 5% by mass or greater, or about 10% by mass or greater, and about 55% by mass or less, about 50% by mass or less, or about 45% by mass or less based on the solid content of the liquid composition. It is possible to improve the adhesion by setting the content of the organic resin to be about 2% by mass or greater. It is possible to improve the flame retardancy by setting the content of the organic resin to be about 55% by mass or less.

It is advantageous that the liquid composition contains a combination of the water glass and the organic resin as the film forming binder.

The liquid composition may contain, as an optional component, an inorganic filler other than clays such as silica gel or glass fiber, a surfactant, a pigment, a preservative and the like as long as the effects of the present disclosure are not lost.

The liquid composition may contain water, an organic solvent, or a combination thereof as a solvent. In one embodiment, the liquid composition is an aqueous composition. The aqueous composition can be suitably used for interior applications where the work environment or construction period is restricted.

In one embodiment, the solid content of the liquid composition is about 1% by mass or greater, about 3% by mass or greater, or about 5% by mass or greater, and about 45% by mass or less, about 40% by mass or less, or about 35% by mass or less. It is possible to enhance the coating suitability by setting the solid content of the liquid composition to be about 45% by mass or less.

It is possible to appropriately determine the viscosity of the liquid composition according to the application method. In one embodiment, the viscosity of the liquid composition can be about 1 mPa·s or greater, about 10 mPa·s or greater, or about 20 mPa·s or greater, and about 5500 mPa·s or less, about 5000 mPa·s or less, or about 4500 mPa·s or less, when measured using a rheometer (DISCOVERY HR-2, TA Instruments Japan Ltd., Shinagawa-ku, Tokyo, Japan).

The liquid composition can be used as a primer composition. In this embodiment, for example, the decorative film or the sheet having the adhesive layer can be attached on the fireproof layer formed using the liquid composition.

The fireproof layer according to one embodiment includes: clay containing at least one selected from the group consisting of a montmorillonite, mica, hectorite, and fluorosilicate; and a dimer or higher phosphate. The clay and the dimer or higher phosphate are as described for the liquid composition. The fireproof layer can block oxygen to suppress the burning of the base material or the like covered by the fireproof layer and the heat generation by the burning.

The fireproof layer can be formed using the liquid composition. The fireproof layer can be formed by applying the liquid composition to the surface of the base material by, for example, spraying, coating, immersion and the like, removing a solvent by air drying or heating as necessary, and heating reactive components such as the water glass to make the reactive components react with each other when containing the reactive components. The heating temperature can generally be from about 40° C. to about 150° C. The heating time can generally be from about 1 minute to about 10 minutes.

In one embodiment, the fireproof layer contains about 30% by mass or greater, about 35% by mass or greater, or about 40% by mass or greater and about 85% by mass or less, about 80% by mass or less, or about 75% by mass or less of clay.

In one embodiment, the fireproof layer contains about 0.1% by mass or greater, about 0.5% by mass or greater, or about 1% by mass or greater and about 10% by mass or less, about 7% by mass or less, or about 5% by mass or less of dimer or higher phosphate.

The fireproof layer may further contain a binder containing at least one selected from the group consisting of the silicate and the organic resin. The silicate may be a condensate of the water glass as described for the liquid composition. The organic resin is as described for the liquid composition.

In one embodiment, the fireproof layer contains, as the binder, about 0.1% by mass or greater, about 0.5% by mass or greater, or about 1% by mass or greater and about 70% by mass or less, about 65% by mass or less, or about 60% by mass or less of silicate.

In one embodiment, the fireproof layer contains, as the binder, about 2% by mass or greater, about 5% by mass or greater, or about 10% by mass or greater and about 55% by mass or less, about 50% by mass or less, or about 45% by mass or less of organic resin.

The solid content (g/m²) of the fireproof layer per unit area is about 1 g/m² or greater, about 3 g/m² or greater, or 5 g/m² or greater, and about 40 g/m² or less, about 35 g/m² or less, or about 30 g/m² or less.

A laminated structure according to one embodiment includes a fireproof layer and a film disposed on the fireproof layer. The film may be a decorative film having a base material film layer and an adhesive layer on a back surface thereof, and may have a decorative layer, such as a printed layer, on a base material film layer directly or through another layer or between the base material film layer and the adhesive layer. The decorative film may be used for an interior or an exterior of a building.

Examples of the base material film layer include at least one selected from the group consisting of polyvinyl chloride, polyurethane, polyethylene, polypropylene, a vinyl chloride-vinyl acetate copolymer, an acrylic resin, cellulose, and a fluorine resin. The base material film layer may be a single layer or a laminate of a plurality of layers.

The adhesive layer may be a pressure sensitive adhesive layer. Examples of the pressure sensitive adhesive layer include an acrylic pressure sensitive adhesive. By using the acrylic pressure sensitive adhesive, excellent durability and discoloration resistance can be imparted to the decorative film. The acrylic pressure sensitive adhesive can be modified easily to adjust the adhesive property according to the applications. The acrylic pressure sensitive adhesive contains at least one tacky acrylic polymer selected from the group consisting of tacky acrylic homopolymers and copolymers. Examples of the acrylic pressure sensitive adhesive contains tacky homopolymers of monomers or tacky copolymers of two or more of these monomers selected from the group consisting of methyl acrylate, butyl acrylate, isoamyl acrylate, isooctyl acrylate, 2-ethylhexyl acrylate, acrylate, methacrylate, acrylamide, methacrylamide, acrylonitrile, and ethacrylonitrile.

The printed layer may be formed using a printing technique such as gravure printing, electrostatic printing, screen printing, inkjet printing, or offset printing.

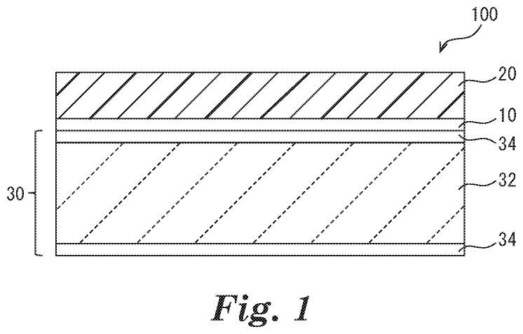

The laminated structure may further contain a base material, such as a wall material of a building, and the fireproof layer may be disposed on the base material. A laminated structure 100 illustrated in schematic cross-sectional view of FIG. 1 has a fireproof layer 10 disposed on a base material 30, and a film 20 is disposed on the fireproof layer 10. In FIG. 1, the base material 30 is shown as one in which both sides of plasterboard 32 are coated with paper 34. Although the fireproof layer 10 is disposed on the base material 30 in FIG. 1, a component of the fireproof layer may penetrate and spread into a part of a surface layer portion of the base material or the entire area of the base material, and a boundary of the fireproof layer are not necessarily clear.

Examples of the base material include plasterboard, mortar, cement, concrete, wood, stone, paper, cloth, glass, plastic, porous ceramics, rock wool acoustic board, calcium silicate board and the like. In one embodiment, the base material is the plasterboard. The plasterboard may have one side or both sides coated with paper. The base material is not limited to a plate-like shape such as a wall material, but the shape and material thereof is not limited as long as it is an object, such as a linear shape, a film shape, a spherical shape, an indeterminate shape, or a three-dimensional shape, to which a liquid composition can be applied.

In the fireproof layer, a sum of total heat values measured for 20 minutes in accordance with the ISO 5660-1 cone calorimeter test for the laminated structure can be set to be, for example, about 8 MJ/m² or less, about 7.2 MJ/m² or less, or about 6.5 MJ/m² or less.

In the fireproof layer, a sum of a total time for which a heat generation rate measured in accordance with the ISO 5660-1 cone calorimeter test for the laminated structure exceeds 200 kW/m² can be set to be about 10 seconds or less, about 8 seconds or less, or about 5 seconds or less.

According to the fireproof material specification value, a material in which the sum of the total heat values measured for 20 minutes is 8 MJ/m² or less and the sum of the total time for which the heat generation rate exceeds 200 kW/m² is 10 seconds or less are classified as an nonflammable material.

The fireproofing method according to one embodiment includes preparing a base material and applying a liquid composition on the base material to form a fireproof layer on the base material. The base material, the liquid composition, and the fireproof layer are as described above.

The fireproofing method may further include applying a film on the fireproof layer. The film is as described above.

The liquid composition, the fireproof layer, the laminated structure, and the fireproofing method according to the present disclosure can be used for various fields where the flame retardant or nonflammable materials are required, such as buildings, automobiles, airplanes, trains and electric/electronic devices.

### EXAMPLES

In the following examples, specific embodiments of the present disclosure will be exemplified, but the present invention is not limited thereto. All “parts” and “percent” are based on mass unless otherwise specified.

Reagents and materials used in this example are shown in Table 1.

TABLE 1
Table 1

| Product name | Description | Manufacturer or provider |
|---|---|---|
| SUMECTON-ST | Synthetic | Kunimine Industries |
| | magnesium | Co., Ltd |
| | silicate | (Chiyoda-ku, |
| | (synthetic | Tokyo, Japan) |
| | steel site) | |
| KUNIPIA-G | Montmorillonite | Kunimine Industries |
| | | Co., Ltd |
| | | (Chiyoda-ku, |
| | | Tokyo, Japan) |
| SOMASIF ME-100 | Hydrophilic | Katakura & Co-op |
| | swellable mica, | Agri Corporation |
| | average diameter | (Chiyoda-ku, |
| | 3~7 μm | Tokyo, Japan) |
| LAPONITE-SL 25 | 25% by mass water | BYK Japan KK |
| | dispersion of | (Shinjuku-ku, Tokyo, |
| | synthetic hectorite | Japan) |
| SUMECTON-SWN | Sodium silicate | Kunimine Industries |
| | magnesium | Co., Ltd |
| | (hectorite) | (Chiyoda-ku, |
| | | Tokyo, Japan) |
| LAPONITE-JS | Synthetic layered | BYK Japan KK |
| | fluorosilicate | (Shinjuku-ku, Tokyo, |
| | | Japan) |
| LAPONITE-S482 | Synthetic Hectorite | BYK Japan KK |
| | | (Shinjuku-ku, Tokyo, |
| | | Japan) |
| 30% of potassium | | FUJIFILM Wako |
| silicate solution | | Pure Chemical |
| | | Corporation (Osaka |
| | | City, Osaka |
| | | Prefecture, Japan) |
| Lithium silicate 75 | Lithium silicate | Nissan Chemical |
| | aqueous solution, | Corporation (Chuo- |
| | 20% by mass of | ku, Tokyo, Japan) |
| | SiO₂, SiO₂/LiO₂ = | |
| | 7.5 (molar ratio) | |
| Sodium | | FUJIFILM Wako |
| diphosphate | | Pure Chemical |
| decahydrate | | Corporation (Osaka |
| | | City, Osaka |
| | | Prefecture, Japan) |
| DP-900N3 | Primer | 3M Japan Limited |
| | | (Shinagawa-ku, |
| | | Tokyo, Japan) |
| VINYBLAN 715 | Vinyl chloride | Nissin Chemical |
| | polymer emulsion, | Co., Ltd. (Echizen |
| | 25% by mass | City, Fukui |
| | of solid content | Prefecture, Japan) |
| OLFINE EXP.4123 | Acetylene-based | Nissin Chemical |
| | surfactant, 40% | Co., Ltd. (Echizen |
| | by mass of | City, Fukui |
| | active ingredient | Prefecture, Japan) |
| Plasterboard GB-R | Thickness 12.5 mm | Yoshino Gypsum |
| | | Co., Ltd. (Chiyoda- |
| | | ku, Tokyo, Japan) |

### Production of Decorative Sheet

38% by mass of solution of an acrylic copolymer was prepared as an acrylic pressure sensitive adhesive composition by copolymerizing a monomer mixture of butyl acrylate/acrylate in ethyl acetate. The resulting pressure sensitive adhesive composition was applied to an embossed PVC film (3M Japan Co., Ltd., Shinagawa-ku, Tokyo, Japan) using a knife coat so that the thickness after drying was 40 μm, thereby preparing the applied decorative sheet. The composition of the PVC film was polyvinyl chloride resin/plasticizer (including diisononyl phthalate)/additive (including acrylic resin and zinc stearate)=76/17/7 (mass ratio).

### Example 1

While 255 g of distilled water was stirred, 15 g of KUNIPIA-G was slowly added and sufficiently stirred. After the mixture was left at room temperature for 12 hours or more, a viscous aqueous dispersion having 5.6% by mass of solid content was obtained. 0.019 g of sodium diphosphate decahydrate and 4.0 g of distilled water were added to 4.0 g of the resulting aqueous dispersion, and the mixture was sufficiently mixed. Thereafter, 0.93 g of 30% potassium silicate solution was mixed to obtain a coating liquid. 4.4 g (0.25 g of solid content) of the resulting coating liquid was applied to plasterboard GB-R (10 cm square), naturally dried, and then stuck to a decorative sheet to obtain a sample for evaluation.

### Example 2

While 255 g of distilled water was stirred, 30 g of SOMASIF ME-100 was slowly added and sufficiently stirred. After the mixture was left at room temperature for 12 hours or more, a viscous aqueous dispersion having 11% by mass of solid content was obtained. 0.036 g of sodium diphosphate decahydrate and 4.0 g of distilled water were added to 4.0 g of the resulting aqueous dispersion, and the mixture was sufficiently mixed. Thereafter, 1.75 g of 30% potassium silicate solution was mixed to obtain a coating liquid. 2.6 g (0.25 g of solid content) of the resulting coating liquid was applied to plasterboard GB-R, naturally dried, and then stuck to a decorative sheet to obtain a sample for evaluation.

### Example 3

0.1 g of distilled water and 0.017 g of sodium diphosphate decahydrate were added to 1.2 g of LAPONITE-SL 25, and the mixture was sufficiently mixed. Thereafter, 0.62 g of VINYBLAN 715 was mixed to obtain a coating liquid. 1.1 g (0.25 g of solid content) of the resulting coating liquid was applied to plasterboard, naturally dried, and then stuck to a decorative sheet to obtain a sample for evaluation.

### Example 4

0.020 g of sodium diphosphate decahydrate was added to 6.0 g of aqueous dispersion of KUNIPIA-G having 5.6% by mass of solid content, and the mixture was sufficiently mixed. Thereafter, 0.73 g of VINYBLAN 715 was mixed to obtain a coating liquid. 3.3 g (0.26 g of solid content) of the resulting coating liquid was applied to plasterboard GB-R, naturally dried, and then stuck to a decorative sheet to obtain a sample for evaluation.

### Example 5

0.020 g of sodium diphosphate decahydrate was added to 6.0 g of aqueous dispersion of KUNIPIA-G having 5.6% by mass of solid content, and the mixture was sufficiently mixed. Next, 0.73 g of VINYBLAN 715 was mixed. Thereafter, 0.05 g of lithium silicate 75 was mixed to obtain a coating liquid. 3.4 g (0.27 g of solid content) of the resulting coating liquid was applied to plasterboard GB-R, naturally dried, and then stuck to a decorative sheet to obtain a sample for evaluation.

### Example 6

While 255 g of distilled water was stirred, 20 g of SUMECTON-SWN was slowly added and sufficiently stirred. After the mixture was left at room temperature for 12 hours or more, a gel having 7.3% by mass of solid content was obtained. 0.034 g of sodium diphosphate decahydrate and 0.4 g of distilled water were added to 8.2 g of the resulting gel, and the mixture was sufficiently mixed. Thereafter, 1.24 g of VINYBLAN 715 was mixed to obtain a coating liquid. 2.7 g (0.25 g of solid content) of the resulting coating liquid was applied to plasterboard GB-R, naturally dried, and then stuck to a decorative sheet to obtain a sample for evaluation.

### Example 7

4.0 g of aqueous dispersion of SOMASIF ME-100 having 11% by mass of solid content and 0.045 g of sodium diphosphate decahydrate were added to 6.0 g of aqueous dispersion of KUNIPIA-G having 5.6% by mass of solid content, and the mixture was sufficiently mixed. Thereafter, 1.6 g of VINYBLAN 715 was mixed to obtain a coating liquid. 2.5 g (0.25 g of solid content) of the resulting coating liquid was applied to plasterboard GB-R, naturally dried, and then stuck to a decorative sheet to obtain a sample for evaluation.

### Example 8

2.0 g of aqueous dispersion of SOMASIF ME-100 having 11% by mass of solid content and 0.022 g of sodium diphosphate decahydrate were added to 3.0 g of aqueous dispersion of KUNIPIA-G having 5.6% by mass of solid content, and the mixture was sufficiently mixed. Next, 44 g of VINYBLAN 715 and 0.12 g of OLFINE EXP. 4123 were mixed. Thereafter, 0.24 g of 30% potassium silicate solution was mixed to obtain a coating liquid. 2.5 g (0.27 g of solid content) of the resulting coating liquid was applied to plasterboard GB-R, naturally dried, and then stuck to a decorative sheet to obtain a sample for evaluation.

### Example 9

While 255 g of distilled water was stirred, 45 g of LAPONITE-JS was slowly added and sufficiently stirred. After the mixture was left at room temperature for 12 hours or more, an aqueous dispersion having 15% by mass of solid content was obtained. 0.056 g of sodium diphosphate decahydrate was added to 5.0 g of the resulting aqueous dispersion, and the mixture was sufficiently mixed. Next, 0.3 g of KUNIPIA-G powder, 1.5 g of VINYBLAN 715, and 0.12 g of OLFINE EXP. 4123 were sufficiently mixed. Thereafter, 0.1 g of lithium silicate 75 was mixed to obtain a coating liquid. 1.2 g (0.26 g of solid content) of the resulting coating liquid was applied to plasterboard GB-R, naturally dried, and then stuck to a decorative sheet to obtain a sample for evaluation.

### Example 10

While 255 g of distilled water was stirred, 45 g of LAPONITE-S 482 was slowly added and sufficiently stirred. After the mixture was left at room temperature for 12 hours or more, an aqueous dispersion having 15% by mass of solid content was obtained. 0.83 g of sodium diphosphate decahydrate was added to 75 g of the resulting aqueous dispersion, and the mixture was sufficiently mixed. Next, 4.5 g of KUNIPIA-G powder was added while stirring and sufficiently mixed. 23 g of VINYBLAN 715 and 1.8 g of OLFINE EXP. 4123 were mixed, and then 1.5 g of lithium silicate 75 was mixed with the mixture to obtain a coating liquid. 1.5 g (0.32 g of solid content) of the resulting coating liquid was applied to plasterboard GB-R, naturally dried, and then stuck to a decorative sheet to obtain a sample for evaluation.

### Comparative Example 1

As a sample for evaluation, plasterboard GB-R was used without being processed.

### Comparative Example 2

2.1 g (0.25 g of solid content) of DP-900N3 was applied to plasterboard GB-R, naturally dried, and then stuck to a decorative sheet to obtain a sample for evaluation.

### Comparative Example 3

0.84 g of sodium diphosphate decahydrate was added to 20 g of distilled water, and the mixture was sufficiently stirred until dissolved to obtain an aqueous dispersion of sodium diphosphate. 10 g (0.24 g of solid content) of the resulting aqueous dispersion was applied to plasterboard GB-R, naturally dried, and then stuck to a decorative sheet to obtain a sample for evaluation.

### Comparative Example 4

While 255 g of distilled water was stirred, 45 g of SUMECTON-ST was slowly added and sufficiently stirred. After the mixture was left at room temperature for 12 hours or more, a gel having 15% by mass of solid content was obtained. 0.052 g of sodium diphosphate decahydrate and 4.0 g of distilled water were added to 4.0 g of the resulting gel, and the mixture was sufficiently mixed. Thereafter, 2.5 g of 30% potassium silicate solution was mixed to obtain a coating liquid. 1.9 g (0.25 g of solid content) of the resulting coating liquid was applied to plasterboard GB-R, naturally dried, and then stuck to a decorative sheet to obtain a sample for evaluation.

### Comparative Example 5

0.035 g of sodium diphosphate decahydrate and 0.2 g of distilled water were added to 4 g of gel made of SUMECTON-ST having 15% by mass of solid content, and the mixture was sufficiently mixed. Thereafter, 1.24 g of VINYBLAN 715 was mixed to obtain a coating liquid. 1.5 g (0.25 g of solid content) of the resulting coating liquid was applied to plasterboard GB-R, naturally dried, and then stuck to a decorative sheet to obtain a sample for evaluation.

### Heat Generating Property Test

Tests were conducted in accordance with the ISO 5660-1 cone calorimeter test. A heat generation rate (kW/m²) and a total heat value (MJ/m²) as parameters were measured using the cone calorimeter (Toyo Seiki Co., Ltd., Kita-ku, Tokyo, Japan). The test was conducted for 20 minutes in the state where a test piece (10 cm×10 cm) was horizontally disposed on the sample installation portion of the cone calorimeter, and was applied with a radiant heat of 50 kW/m² from above the test piece given by a cone type electric heater to be ignited by a fire of an electric spark. The heat value was determined based on oxygen consumption by combustion gas analysis. A case where the sum of the total heat values measured for 20 minutes after the start of heating is 8 MJ/m² or less, and the sum of the total time indicating the heat generation rate exceeding 200 kW/m² is 10 seconds or less was judged to pass, or cases other than the case were judged to fail.

TABLE 2-1
Table 2 (blending represents part of mass of solid content)

| | Example | Example | Example | Example | Example |
|---|---|---|---|---|---|
| | 1 | 2 | 3 | 4 | 5 |
| SMECTON-ST | — | — | — | — | — |
| KUNIPIA-G | 43.4 | — | — | 64.2 | 62.9 |
| SOMASIF ME-100 | — | 43.5 | — | — | — |
| LAPONITE-SL 25 | — | — | 65.4 | — | — |
| SUMECTON-SWN | — | — | — | — | — |
| LAPONITE-JS | — | — | — | — | — |
| LAPONITE-S482 | — | — | — | — | — |
| 30% of potassium | 54.4 | 54.3 | — | — | — |
| silicate solution | | | | | |
| Lithium silicate 75 | — | — | — | — | 2.01 |
| Sodium diphosphate | 2.21 | 2.22 | 2.21 | 2.28 | 2.23 |
| decahydrate | | | | | |
| DP900N3 | — | — | — | — | — |
| VNYBLAN 715 | — | — | 32.4 | 33.5 | 32.8 |
| OLFINE EXP 4123 | — | — | — | — | — |
| Solid content (% by | 5.7 | 9.9 | 24 | 7.7 | 7.9 |
| mass) of liquid | | | | | |
| composition | | | | | |
| Coating amount (g) | 4.4 | 2.6 | 1.1 | 3.3 | 3.4 |
| Solid content (g/m²) | 25 | 25 | 25 | 26 | 27 |
| of fireproof layer | | | | | |
| Application of | Presence | Yes | Yes | Yes | Yes |
| decorative sheet | | | | | |
| Total heat value | 7.4 | 7.6 | 7.7 | 6.3 | 5.8 |
| (MJ/m²) for 20 | | | | | |
| minutes | | | | | |
| Total time (second) | 0 | 5.8 | 2.8 | 2.9 | 3.8 |
| exceeding 200 | | | | | |
| kW/m² | | | | | |

TABLE 2-2
(Continuation of Table 2)

| | Example | Example | Example | Example | Example |
|---|---|---|---|---|---|
| | 6 | 7 | 8 | 9 | 10 |
| SMECTON-ST | — | — | — | — | — |
| KUNIPIA-G | — | 28.3 | 26.8 | 19.7 | 19.7 |
| SOMASIF ME-100 | — | 37.1 | 35.1 | — | — |
| LAPONITE-SL | — | — | — | — | — |
| SUMECTON-SWN | 65.2 | — | — | — | — |
| LAPONITE-JS | — | — | — | 49.3 | — |
| LAPONITE-S482 | — | — | — | — | 49.3 |
| 30% of potassium silicate | — | — | 11.5 | — | — |
| solution | | | | | |
| Lithium silicate 75 | — | — | — | 1.41 | 1.41 |
| Sodium diphosphate | 2.22 | 2.26 | 2.09 | 2.19 | 2.17 |
| decahydrate | | | | | |
| DP900N3 | — | — | — | — | — |
| VNYBLAN 715 | 32.6 | 32.4 | 16.8 | 24.3 | 24.3 |
| OLFINE EXP 4123 | — | — | 7.66 | 3.15 | 3.15 |
| Solid content (% by mass) | 9.3 | 10 | 11 | 21 | 21 |
| Coating amount (g) | 2.7 | 2.5 | 2.5 | 1.2 | 1.5 |
| Solid content (g/m²) of | 25 | 25 | 27 | 26 | 32 |
| fireproof layer | | | | | |
| Application of decorative | Yes | Yes | Yes | Yes | Yes |
| sheet | | | | | |
| Total heat value (MJ/m²) | 7.3 | 7.2 | 6.4 | 7.4 | 7.1 |
| for 20 minutes | | | | | |
| Total time (second) | 4.3 | 8.9 | 3.4 | 5.2 | 7.7 |
| exceeding 200 kW/m² | | | | | |

TABLE 2-3
(Continuation of Table 2)

| | Comparative | Comparative | Comparative | Comparative | Comparative |
|---|---|---|---|---|---|
| | Example 1 | Example 2 | Example 3 | Example 4 | Example 5 |
| SMECTON-ST | | — | — | 43.4 | 65.3 |
| KUNIPIA-G | | — | — | — | — |
| SOMASIF ME-100 | | — | — | — | — |
| LAPONITE-SL | | — | — | — | — |
| SUMECTON-SWN | | — | — | — | — |
| LAPONITE-JS | | — | — | — | — |
| LAPONITE-S482 | | — | — | — | — |
| 30% of potassium silicate solution | | — | — | 54.3 | — |
| Lithium silicate 75 | | — | — | — | — |
| Sodium diphosphate decahydrate | | — | 100 | 2.24 | 2.27 |
| DP900N3 | | 100 | — | — | — |
| VNYBLAN 715 | | — | — | — | 32.4 |
| OLFINE EXP 4123 | | — | — | — | — |
| Solid content (% by mass) of liquid | | 12 | 2.4 | 13 | 17 |
| composition | | | | | |
| Coating amount (g) | | 2.1 | 10 | 1.9 | 1.5 |
| Solid content (g/m²) of fireproof | | 25 | 24 | 25 | 25 |
| layer | | | | | |
| Application of decorative sheet | Absence | Yes | Yes | Yes | Yes |
| Total heat value (MJ/m²) for 20 | 5.2 | 8.8 | 9.9 | 9.4 | 10 |
| minutes | | | | | |
| Total time (second) exceeding 200 | 0 | 0 | 0 | 0 | 0 |
| kW/m² | | | | | |

Various modifications of the above embodiments and examples will be apparent to those skilled in the art without departing from the basic principle of the present invention. It is also obvious to a person skilled in the art that various improvement and modifications to the present invention can be implemented without departing from the spirit and scope of the present invention.

### REFERENCE SIGNS LIST

10 Fireproof layer
20 Film
30 Base material
32 Plasterboard
34 Paper
100 Laminated structure

1. A liquid composition comprising:
clay containing at least one selected from the group consisting of a montmorillonite, mica, hectorite, and fluorosilicate; and
a dimer or higher phosphate.

2. The liquid composition according to claim 1, further comprising a film forming binder containing at least one selected from the group consisting of a water glass and an organic resin.

3. The liquid composition according to claim 1, wherein the clay contains the montmorillonite.

4. The liquid composition according to claim 1, wherein the liquid composition is a primer composition.

5. The liquid composition according to claim 1, wherein the liquid composition contains from 30% by mass to 85% by mass of the clay based on a solid content of the liquid composition.

6. The liquid composition according to claim 1, wherein the liquid composition contains from 0.1% by mass to 10% by mass of the dimer or higher phosphate based on the solid content of the liquid composition.

7. A fireproof layer comprising:
clay containing at least one selected from the group consisting of a montmorillonite, mica, hectorite, and fluorosilicate; and
a dimer or higher phosphate.

8. The fireproof layer according to claim 7, further comprising a binder containing at least one selected from the group consisting of a silicate and an organic resin.

9. The fireproof layer according to claim 7, wherein a solid content per unit area of the fireproof layer is from 1 g/m² to 40 g/m².

10. The fireproof layer according to claim 7, wherein the clay contains the montmorillonite.

11. A laminated structure, comprising:
a fireproof layer including clay containing at least one selected from the group consisting of a montmorillonite, mica, hectorite, and fluorosilicate, and a dimer or higher phosphate; and
a film disposed on the fireproof layer.

12. The laminated structure according to claim 11, wherein the fireproof layer further includes a binder containing at least one selected from the group consisting of a silicate and an organic resin.

13. The laminated structure according to claim 11, wherein the clay contains the montmorillonite.

14. The laminated structure according to claim 11, wherein the film is a decorative film including a base material layer, a decorative layer, and an adhesive layer.

15. The laminated structure according to claim 11, further comprising a base material, wherein the fireproof layer is disposed on the base material.

16. The laminated structure according to claim 15, wherein the base material is a plasterboard.

17. A fireproofing method, comprising:
preparing a base material; and
applying a liquid composition on the base material to form a fireproof layer on the base material, wherein
the liquid composition contains:
clay containing at least one selected from the group consisting of a montmorillonite, mica, hectorite, and fluorosilicate; and
a dimer or higher phosphate.

18. The fireproofing method according to claim 17, wherein the liquid composition further contains a film forming binder containing at least one selected from the group consisting of a water glass and an organic resin.

19. (canceled)

20. (canceled)

21. The fireproofing method according to claim 17, further comprising applying a film to the fireproof layer.

22. The fireproofing method according to claim 21, wherein the film is a decorative film including a base material layer, a decorative layer, and an adhesive layer.
